(19) United States
(12) Patent Application Publication
(10) Pub. No.: US 2013/0188954 A1
(43) Pub. Date: Jul. 25, 2013

(54) RFoG CPE Devices with Wavelength Collision Avoidance Using Laser Transmitter Local and/or Remote Tunability

(71) Applicants: Joseph P. Lanza, Ozark, MO (US); Charles D. Combs, Buffalo, MO (US)

(72) Inventors: Joseph P. Lanza, Ozark, MO (US); Charles D. Combs, Buffalo, MO (US)

(21) Appl. No.: 13/557,978

(22) Filed: Jul. 25, 2012

Related U.S. Application Data
(60) Provisional application No. 61/572,942, filed on Jul. 25, 2011.
(60) Provisional application No. 61/573,646, filed on Sep. 9, 2011.

(51) Int. Cl. H04B 10/2575

(52) U.S. Cl. CPC H04B 10/2575
USPC 398/68

(57) ABSTRACT

Methods and apparatus are described for RFoG CPE devices with wavelength collision avoidance using local and/or remote tunability. A method includes tuning each of a plurality of optical transmitters to a plurality of non-overlapping frequency bands to avoid wavelength collisions in an upstream portion of a multipoint-to-point RFoG network where multiple optical transmitters from different RFoG CPE units transmit at the same time to a single shared optical receiver.

### CROSS-REFERENCES TO RELATED APPLICATIONS

This application claims a benefit of priority under 35 U.S.C. 119(e) from both copending provisional patent application U.S. Ser. No. 61/572,942, filed Jul. 25, 2011 and copending provisional patent application U.S. Ser. No. 61/573,646, filed Sep. 9, 2011, the entire contents of both of which are hereby expressly incorporated herein by reference for all purposes.

BACKGROUND INFORMATION

1. Field of the Invention

Embodiments of the invention relate generally to the field of RFoG networking. More particularly, an embodiment of the invention relates to methods and apparatus to avoid wavelength collisions in an upstream multipoint-to-point RFoG network where multiple optical transmitters from different RFoG CPE units transmit at the same time to a single shared optical receiver.

2. Discussion of the Related Art

### First Generation RFoG System (SCTE IPS SP910 RFoG Standard)

RF over Glass (RFoG) is the name given to the generic FTTH (fiber to the home) PON (passive optical network) architecture currently being deployed by broadband coaxial telecommunication network operators as one of the possible implementation of broadband telecommunication systems carrying basically the same signals as traditional hybrid fiber-coax (HFC) networks. FIG. 1 shows the schematic diagram of a first-generation RFoG PON system (SCTE IPS SP910 RFoG Standard).

In this RFoG architecture, traditional cable services (analog and digital video, VOD (video on demand), VolP (voice over internet protocol), HSD (high speed data), etc.) are transported downstream on wavelength λ_{d1} (typically 1550 nm). Meanwhile cable upstream signals are on wavelength λᵤ₁.

The downstream signal on wavelength λ_{d1} may be optically amplified in the headend/hub and broadcast to all the customer premise equipment (CPEs). The upstream data signals on wavelength λᵤ₁ originate from cable modems or other customer premise devices with two-way communication capability (e.g., set-top boxes) attached to the RFoG CPEs, at some RF frequency assigned to upstream communication. After optical detection at the optical receiver 110, the upstream RF (radio frequency) signals is extracted by the band-pass filter (BPF) 120 and fed to the communication equipment (for example, cable modem termination system (CMTS)) input in the headend/hub.

Although the upstream signals from all CPEs operate at the same wavelength (λᵤ₁), and are combined together by the optical splitter/combiner and received by a single optical receiver, wavelength collisions are avoided at the upstream optical receiver as long as customer premise terminal equipment for all customers attached to the same receiver operates in strictly time-division multiple access (TDMA) mode in a single MAC domain and no more than one CPE laser can transmit at the same time (the lasers are muted if there is no transmission in strictly TDMA mode). That is, the upstream MAC (deployed for example in CMTS) protocol permits only one customer premise equipment to transmit data upstream at any given time.

The CPE upstream transmitters employ burst-mode transmission in the upstream path to ensure that the upstream path laser in the CPE only turns on when it detects incoming data from the cable modem and is off the rest of the time. In this manner, upstream wavelength collisions are avoided. Avoiding wavelength collisions is of critical importance in an RFoG system—if two optical signals with the same wavelength are incident on a single receiver, optical beating causes a severe degradation of the signal-to-noise ratio (SNR) over the entire return path bandwidth rendering the receiver unable to detect any signals for the duration of the wavelength collision. Thus the RFoG architecture shown in FIG. 1 supports single MAC TDMA protocol communication only.

### SUMMARY OF THE INVENTION

There is a need for the following embodiments of the invention. Of course, the invention is not limited to these embodiments.

According to an embodiment of the invention, a method comprises: tuning each of a plurality of optical transmitters to a plurality of non-overlapping frequency bands to avoid wavelength collisions in an upstream portion of a multipoint-to-point RFoG network where multiple optical transmitters from different RFoG CPE units transmit at the same time to a single shared optical receiver. According to another embodiment of the invention, an apparatus comprises: a plurality of optical transmitters that are tuned to a plurality of non-overlapping frequency bands to avoid wavelength collisions in an upstream portion of a multipoint-to-point RFoG network where multiple optical transmitters from different RFoG CPE units transmit at the same time to a single shared optical receiver.

These, and other, embodiments of the invention will be better appreciated and understood when considered in conjunction with the following description and the accompanying drawings. It should be understood, however, that the following description, while indicating various embodiments of the invention and numerous specific details thereof, is given for the purpose of illustration and does not imply limitation. Many substitutions, modifications, additions and/or rearrangements may be made within the scope of embodiments of the invention, and embodiments of the invention include all such substitutions, modifications, additions and/or rearrangements.

### BRIEF DESCRIPTION OF THE DRAWINGS

The drawings accompanying and forming part of this specification are included to depict certain embodiments of the invention. A clearer concept of embodiments of the invention, and of components combinable with embodiments of the invention, and operation of systems provided with embodiments of the invention, will be readily apparent by referring to the exemplary, and therefore nonlimiting, embodiments illustrated in the drawings (wherein identical reference numerals (if they occur in more than one view) designate the same elements). Embodiments of the invention may be better understood by reference to one or more of these drawings in combination with the following description presented herein. It should be noted that the features illustrated in the drawings are not necessarily drawn to scale.

FIG. 1 illustrates an RFoG architecture where traditional cable services are transported downstream on wavelength λ_{d1} and cable upstream signals are transported on wavelength λᵤ₁, appropriately labeled “PRIOR ART.”

FIG. 2 illustrates an enhanced RFoG architecture that supports multiple return services on a single upstream wavelength.

FIG. 3 illustrates an RFoG system that reduces the probability of OBI (optical beat interference) by employing multiple, closely-spaced upstream wavelengths by means of CPE laser transmitters with hardware DIP switches, representing an embodiment of the invention.

FIG. 4 illustrates an RFoG system with control signal embedded in downstream signal to remotely tune CPE wavelengths using laser heaters and/or thermo-electric coolers, representing an embodiment of the invention.

### DESCRIPTION OF PREFERRED EMBODIMENTS

Embodiments of the invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the embodiments of the invention in detail. It should be understood, however, that the detailed description and the specific examples, while indicating preferred embodiments of the invention, are given by way of illustration only and not by way of limitation. Various substitutions, modifications, additions and/or rearrangements within the scope of the underlying inventive concept will become apparent to those skilled in the art from this disclosure.

RFoG Systems Supporting Multiple Services with Each Service Deploying Its Own MAC Protocol (more than one CPE lasers can transmit at the same time)

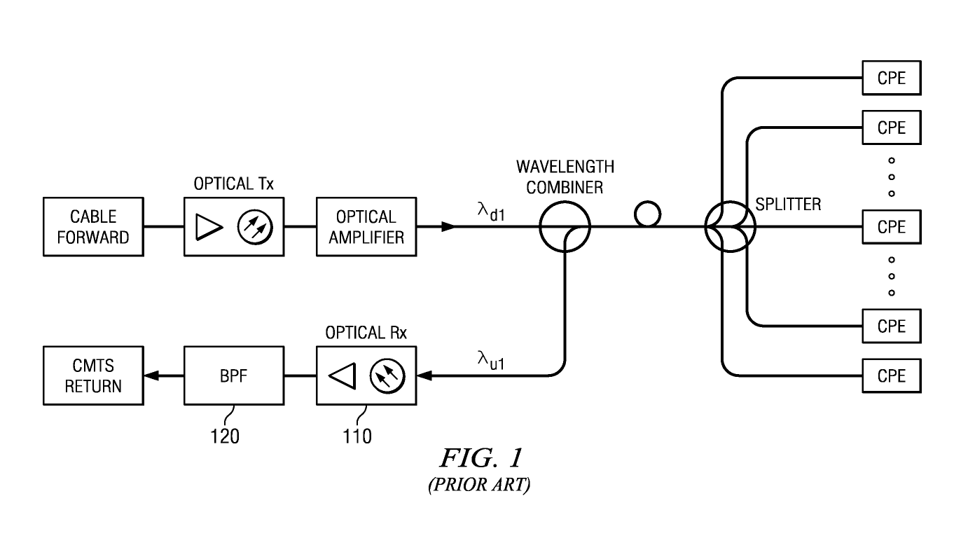

A disadvantage of the first-generation RFoG architecture shown in FIG. 1 is the fact that only one service with single MAC TDMA mode is supported in the return band (a QAM channel at a RF frequency between 5-45 MHz in North America, 5-65 MHz in Europe or any other band assigned to the upstream path communication in multipoint-to-point topology). If more than one service is carried (for example data service and set top box upstream signaling channels with different TDMA MAC protocols, but other multiple services are also possible) or the service carried uses other than TDMA MAC protocol (for example OFDMA or S-CDMA) or a CPE upstream laser other than the one carrying the signal is triggered accidentally at the same time (for example by ingress RF signal), a service disruption may occur.

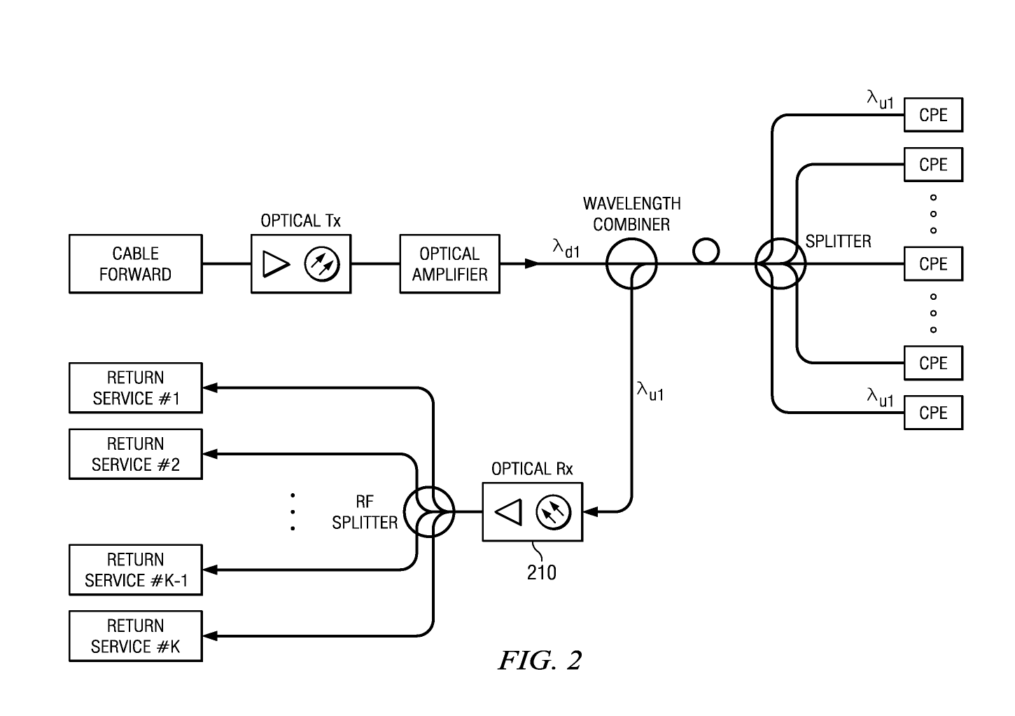

An attractive alternative to the conventional RFoG architecture of FIG. 1 is an enhanced version that supports multiple services, each with its own TDMA MAC protocol or protocols different than TDMA MAC (for example, OFDMA or S-CDMA), as shown in FIG. 2.

Referring to FIG. 2, this enhanced system supports K upstream services (with K≧1) with each service deploying its own MAC protocol. If K=1 then (as in FIG. 1) there is only one MAC domain and hence there is no chance that two lasers are in the ON-state simultaneously. Some form of laser “squelch” circuit is needed in all CPEs that shuts off the CW laser output when there is no RF input.

Referring to FIG. 2, when K upstream services with different MAC domains are present with K>1, then the possibility arises that as many as K CPE upstream lasers are in the ON-state simultaneously. Since all CPE upstream lasers operate in the same wavelength band (nominal wavelength λᵤ₁) there is a non-zero probability of “laser wavelength collisions” occurring. The major concern about the viability of the enhanced RFoG architecture of FIG. 2 is in preventing such laser wavelength collisions.

Such wavelength collisions can result in laser optical beat interference (OBI) that causes a receiver 210 noise floor to greatly increase. If the two optical signals that are colliding are co-polarized and have wavelengths that are closer together than several times the laser chirp of these transmitters then the signal-to-noise ratio (SNR) can degrade to such an extent that all RF data on the receiver output is lost.

An object of embodiments of the invention is to prevent wavelength collisions (e.g. OBI) in the upstream multipoint-to-point RFoG networks where services with multiple TDMA MAC protocols (or non-TDMA MAC protocols) operate and can cause multiple optical transmitters from different RFoG CPE units to transmit at the same time to a single shared optical receiver. It can be appreciated that in addition to a data signal, some sufficient level ingress RF energy could also trigger transmitters to transmit simultaneously with transmitters that are at that time transmiting data signals. Such a wavelength collision-avoidance system can be comprised of: a) a hardware method, such as DIP switches, to set the laser wavelength of the CPE devices in the RFoG system and/or b) a software method to remotely adjust the laser wavelengths of the CPE devices using control signals sent via the downstream wavelength λ_{d1} (typically 1550 nm).

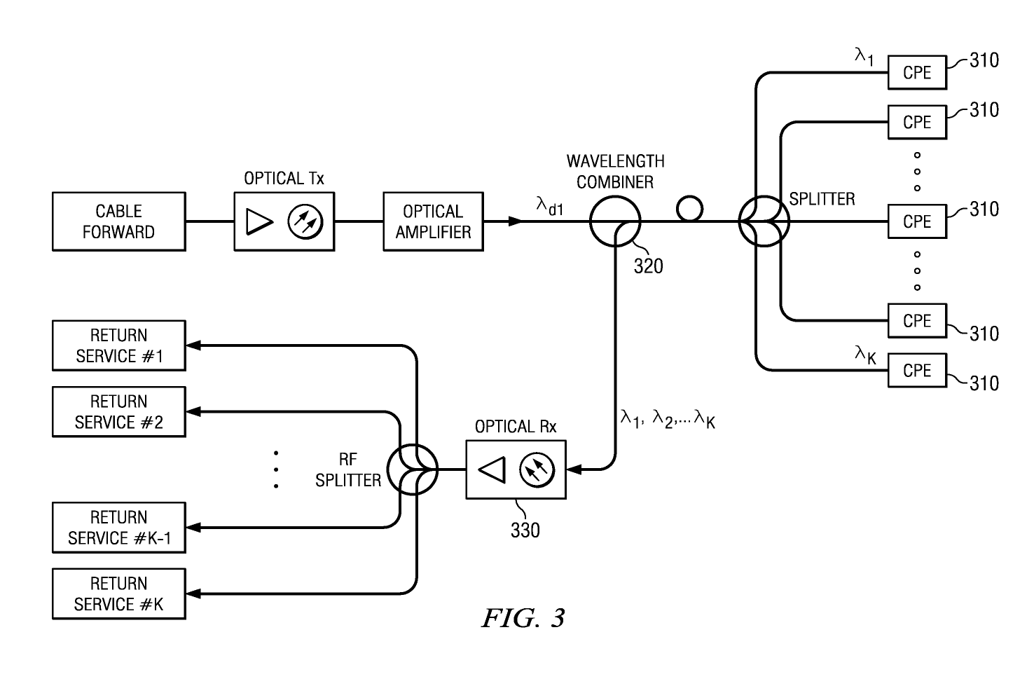

FIG. 3 shows an RFoG system where hardware controls on the CPE 310 transmitters, such as DIP switches, have been used to set the CPE upstream laser wavelengths to one of a set of n wavelengths {λ₁, λ₂, . . . λ_{K}}. This is a first embodiment of the invention. The DIP switches can be manually actuated.

The K upstream wavelengths λᵢ are separated by a sufficient amount to avoid OBI (optical beat interference) but close enough that all wavelengths pass through the optical filter at the headend/hub. The optical filter is not shown in FIG. 3, but can be located between the wavelength combiner 320 and the optical receiver 330. An upper limit to K is the temperature stability that is possible using laser heaters and/or TEC (thermoelectric coolers). For example, since lasers typically have a wavelength coefficient of 0.08 nm/C, a temperature stability of 1° C. would permit laser wavelengths to be spaced on a 0.08 nm (˜10 GHz in the C-Band) grid. This would permit a maximum of 128 return wavelengths in the C-Band if the filter bandwidth is 10 nm (greater than this if the filter bandwidth is higher or a wider wavelength band is utilized).

In the above example, if an RFoG group served by a single receiver (e.g. 330) has fewer than 128 CPEs, the DIP switches on the laser transmitters can be set to unique wavelengths thereby eliminating the possibility of laser OBI. If there are a larger number of CPEs, then this technique can still be used to greatly lower the probability of OBI occurring.

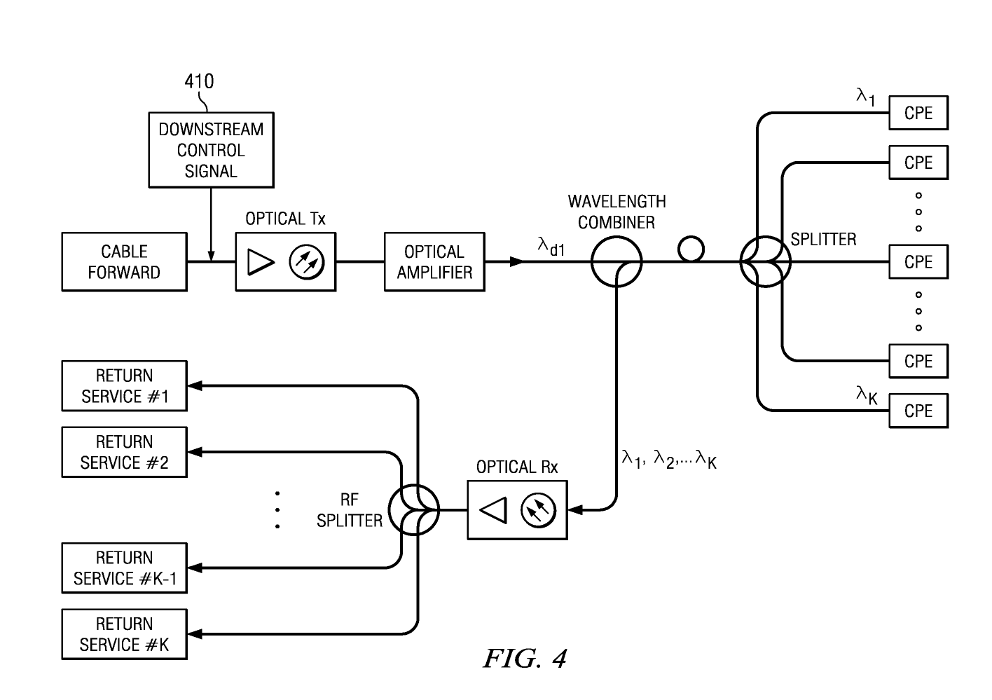

A second embodiment of the invention can include the use of downstream control signals 410 to remotely tune the CPE wavelengths as shown in FIG. 4. A pilot tone modulated by a control signal is inserted into the downstream wavelength λ_{d1} for the purpose of tuning the CPE upstream transmitter wavelengths. This wavelength tuning can again use temperature tuning employing laser heaters and/or thermo-electric coolers.

The remote tunability feature can be used instead of, or in addition to, the use of hardware DIP switches, whereas the use of hardware switches means that the wavelengths are constrained to one of K discrete wavelengths {λ₁, λ₂, . . . λ_{K}} while the use of remote tuning means that the wavelengths can be continuously tuned, for example to a value halfway between two adjacent wavelengths. This allows for more flexibility and a lower probability of OBI occurrence in the RFoG system.

An embodiment of the invention can include an RFoG CPE device with a hardware switch, such as a DIP switch, to set the laser wavelength as shown in FIG. 3. Such hardware switches can be used in combination with laser heating and thermo-electric cooling to one of a set of K wavelengths {λ₁, λ₂, . . . λ_{K}}. This will allow for the total elimination of laser OBI for RFoG systems with a relatively small number of CPE devices (e.g., up to a maximum of 128 CPEs per receiver for a filter bandwidth of 10 nm in the C-Band) or a lower probability of OBI in larger RFoG systems.

An embodiment of the invention can include an RFoG system in which downstream control signals are used to remotely tune the CPE wavelengths as shown in FIG. 4. A pilot tone modulated by a low bit-rate digital signal is inserted into the downstream wavelength λ_{d1} for the purpose of tuning the CPE wavelengths. Such remote tuning can again be used in combination with ses temperature tuning employing laser heaters and/or thermo-electric coolers. The remote tunability feature can be used instead of, or in addition to, the use of hardware DIP switches. Whereas the use of hardware switches means that the wavelengths are constrained to one of K discrete wavelengths {λ₁, λ₂, . . . λ_{K}}, the use of remote tuning means that the wavelengths can be continuously tuned, for example to a value halfway between two adjacent wavelengths. This allows for more flexibility and a lower probability of OBI occurrence in the RFoG system.

### Definitions

The terms program and/or software and/or the phrases computer program and/or computer software are intended to mean a sequence of instructions designed for execution on a computer system (e.g., a program and/or computer program, may include a subroutine, a function, a procedure, an object method, an object implementation, an executable application, an applet, a servlet, a source code, an object code, a shared library/dynamic load library and/or other sequence of instructions designed for execution on a computer or computer system).

The term substantially is intended to mean largely but not necessarily wholly that which is specified. The term approximately is intended to mean at least close to a given value (e.g., within 10% of). The term generally is intended to mean at least approaching a given state. The term coupled is intended to mean connected, although not necessarily directly, and not necessarily mechanically.

The terms first or one, and the phrases at least a first or at least one, are intended to mean the singular or the plural unless it is clear from the intrinsic text of this document that it is meant otherwise. The terms second or another, and the phrases at least a second or at least another, are intended to mean the singular or the plural unless it is clear from the intrinsic text of this document that it is meant otherwise. Unless expressly stated to the contrary in the intrinsic text of this document, the term or is intended to mean an inclusive or and not an exclusive or. Specifically, a condition A or B is satisfied by any one of the following: A is true (or present) and B is false (or not present), A is false (or not present) and B is true (or present), and both A and B are true (or present). The terms a and/or an are employed for grammatical style and merely for convenience.

The term plurality is intended to mean two or more than two. The term any is intended to mean all applicable members of a set or at least a subset of all applicable members of the set. The term means, when followed by the term “for” is intended to mean hardware, firmware and/or software for achieving a result. The term step, when followed by the term “for” is intended to mean a (sub)method, (sub)process and/or (sub)routine for achieving the recited result. Unless otherwise defined, all technical and scientific terms used herein have the same meaning as commonly understood by one of ordinary skill in the art to which this invention belongs. In case of conflict, the present specification, including definitions, will control.

### CONCLUSION

The described embodiments and examples are illustrative only and not intended to be limiting. Although embodiments of the invention can be implemented separately, embodiments of the invention may be integrated into the system(s) with which they are associated. All the embodiments of the invention disclosed herein can be made and used without undue experimentation in light of the disclosure. Although the best mode of the invention contemplated by the inventor(s) is disclosed, embodiments of the invention are not limited thereto. Embodiments of the invention are not limited by theoretical statements (if any) recited herein. The individual steps of embodiments of the invention need not be performed in the disclosed manner, or combined in the disclosed sequences, but may be performed in any and all manner and/or combined in any and all sequences. The individual components of embodiments of the invention need not be combined in the disclosed configurations, but could be combined in any and all configurations.

Various substitutions, modifications, additions and/or rearrangements of the features of embodiments of the invention may be made without deviating from the scope of the underlying inventive concept. All the disclosed elements and features of each disclosed embodiment can be combined with, or substituted for, the disclosed elements and features of every other disclosed embodiment except where such elements or features are mutually exclusive. The scope of the underlying inventive concept as defined by the appended claims and their equivalents cover all such substitutions, modifications, additions and/or rearrangements.

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. A method, comprising tuning each of a plurality of optical transmitters to a plurality of non-overlapping frequency bands to avoid wavelength collisions in an upstream portion of a multipoint-to-point RFoG network where multiple optical transmitters from different RFoG CPE units transmit at the same time to a single shared optical receiver.

2. The method of claim 1, wherein tuning includes local tuning.

3. The method of claim 2, wherein local tuning includes selecting an output frequency.

4. The method of claim 3, wherein selecting an output frequency includes setting a DIP switch.

5. The method of claim 2, further comprising remote tuning each of the plurality of transmitters.

6. The method of claim 5, wherein remote tuning includes selecting a heater set point and a thermoelectric cooler set point.

7. The method of claim 1, wherein tuning includes remote tuning.

8. The method of claim 7, wherein remote tuning includes selecting a heater set point and a thermoelectric cooler set point.

9. The method of claim 7, further comprising local tuning each of the plurality of transmitters.

10. The method of claim 9, wherein local tuning includes selecting an output frequency.

11. The method of claim 10, wherein selecting an output frequency includes setting a DIP switch.

12. An apparatus, comprising a plurality of optical transmitters that are tuned to a plurality of non-overlapping frequency bands to avoid wavelength collisions in an upstream portion of a multipoint-to-point RFoG network where multiple optical transmitters from different RFoG CPE units transmit at the same time to a single shared optical receiver.

13. The apparatus of claim 12, wherein each of the optical transmitters includes an output frequency selector.

14. The apparatus of claim 13, wherein the output frequency selector includes a DIP switch.

15. The apparatus of claim 12, wherein each of the optical transmitters includes temperature control equipment.

16. The apparatus of claim 15, wherein the temperature control equipment includes a heater and a thermoelectric cooler.

17. An RFoG network, comprising the apparatus of claim 12.
